(19) United States
(12) Patent Application Publication
(10) Pub. No.: US 2011/0146919 A1
(43) Pub. Date: Jun. 23, 2011

(54) Adjustable blind for irregularly-shaped windows

(76) Inventors: Roderick L. Smith, Rio Rancho, NM (US); Rosa M. Silva-Smith, Rio Rancho, NM (US)

(21) Appl. No.: 12/653,992

(22) Filed: Dec. 22, 2009

(51) Int. Cl. E06B 9/38

(52) U.S. Cl. 160/115

(57) ABSTRACT

There is disclosed a window blind suitable for use in arch-type and semi-circle windows, including windows having a curved side defined by a radius, including irregularly shaped windows having a curved side with a varying radius. The apparatus is designed to provide both privacy and shade, and may also be readily opened and closed. A plurality of slats is pivotal in relation to a mounting base or base, and can be deployed into an array to cover the entirety of a semi-circular window.

The apparatus features a mounting base, which serves as the foundation for the complete apparatus. The mounting base typically is generally rectilinear, so to be suited for fastened attachment (as by mounting brackets and screws, or the like) to the “flat” or straight side of an arched or roughly semi-circular window. Other principal components of the apparatus include a plurality of slats which are pivotally attached to the mounting base. The slats are grouped into clusters, whereby a plurality of slats in a cluster is pivotable about a commonly shared point of attachment to the base. Some or all the slats may have adjustable axial lengths. Thus, the longitudinal dimension of a given slat may be adjustable independently of the length of any other bade, including adjacent slats, to permit the shape of the apparatus when opened to be closely adapted to the shape of the window opening.

### FIELD OF THE INVENTION (TECHNICAL FIELD)

The present invention relates to aperture coverings, particularly window coverings and blinds, and specifically to a window blind for use in a window having a curved side.

### BACKGROUND OF THE INVENTION

The desirability of arched windows (also called circular and semi-circular windows) is evidenced by their popularity in homes of all economic classes, from humble mass-produced homes to upper-end custom homes. Along with the pleasing appearance of windows of this design comes the challenge of finding suitable window coverings. The opinion there is a strong demand for suitable coverings is supported by the numerous attempts that have been made by those desiring to design a covering that is able to effectively provide privacy, and reduce or block light and heat, and may also be easily opened and closed by the homeowner. An additional challenge of arched windows is that while they may appear to be symmetrical most tend to have a curved side defined by an ellipse or parabola, requiring blinds that are designed to be adaptable to the irregularity of the curve.

Of the several attempts that have been made to provide a window covering solution for arched windows, a relatively small number of blinds are actually produced and readily available to homeowners. Available blinds for arch windows which our research revealed currently on the market are a fixed, i.e., immovable, honeycomb design and other fixed fabric and wood types, wood shutter-type blinds, and another fabric blind that may be opened and closed remotely, which appears to require a frame that encompasses the entire window used to conceal the cords and other components required to operate the blinds. While patents exist for movable wood slat blinds, these designs appear to be either too cumbersome or impractical for other reasons to produce. No blinds consisting of wood or other solid material movable slats were found which are being produced and available for public consumption.

Therefore, homeowners desiring to match the wood blind coverings installed on the square and rectangular windows in their homes do not currently have this option available to them. The issues that need to be effectively addressed in the design of a suitable arched window covering are: how to make the slats adaptable to the irregularities of the curve, since, as previously stated, arched windows tend to have a curved side defined by an ellipse or parabola, requiring blinds that may adapt, or be adapted, to the irregularity of the curves; how to make the blind ascetically appealing; how to make the blind in such a way that it may be opened and closed; and how to operate the blinds, i.e., the method or methods by which the blinds may be opened with ease to enjoy the view and sunlight, or moonlight, and be closed to provide privacy and shade, not only when the blinds are readily accessible, but also when they are installed at a height that makes them inaccessible to the homeowner.

The presently disclosed apparatus was developed in view of the foregoing background, and successfully addresses each of these requirements, while utilizing wood or other solid material slats that may be selected to match existing wood or other solid material blinds in the home, or any other application.

### BRIEF DESCRIPTION OF THE DRAWINGS

The attached drawings, which form part of the disclosure, are as follows:

FIG. 1 is a perspective front view of a preferred embodiment of the apparatus according to this disclosures, shown mounted in a window opening in a wall of a structure, and having a left-side cluster of blind slats deployed in a window closed condition, and a right-side cluster of blind slats retracted to a window open condition;

FIG. 2 is a perspective front view, partially exploded, of mounting base components of a preferred embodiment of the apparatus, which component is installed on a side or bottom of a window or other aperture;

FIG. 3 is a partially sectional front view of a preferred embodiment of the presently disclosed apparatus, showing the apparatus partially deployed to cover about one-half of a semicircular window;

FIG. 4A is a front view of a single slat component, shown in a compressed position, of one preferred embodiment of the apparatus, there being a plurality of like slats provided in a complete embodiment;

FIG. 4B is a front view of the single slat component depicted in FIG. 4A, but shown in an extended or rest position;

FIG. 4C is a front view of an alternative slat component according to the present disclosure, the slats can be in many different shapes;

FIG. 5A is a view of the single slat component depicted in FIG. 4A, with portions of the slat cut-away to reveal certain interior features and components of the slat;

FIG. 5B is a view of the single slat component depicted in FIG. 4B, with portions of the slat cut-away to reveal certain interior features and components of the slat;

FIG. 6 is a diagrammatic view of an alternative, spring-assisted embodiment of the blind apparatus according to this disclosure, as may be used to cover and uncover a quarter-circle window;

FIG. 7 is a rear view of a spring-assisted alternative embodiment of the apparatus according to this disclosure, showing both clusters of slats deployed to the window closed position;

FIG. 7A is an enlarged perspective view of a clip-hook component of the apparatus seen in FIG. 7;

FIG. 8 is an end or side sectional view, taken along section 8-8 in FIG. 7, of the apparatus seen in FIG. 7;

FIG. 9 is a rear view of an apparatus according to this disclosure, very similar to the version depicted in FIG. 7, showing the left-side cluster of slats partially retracted toward the window open position, by means of a pull cord;

FIG. 10 is an enlarged front view of the distal end of a slat component of the apparatus according to this disclosure, showing a possible means for attaching a clip-hoop thereto;

FIG. 11 is a side, partially sectional view, of the slat component shown in FIG. 10;

FIG. 12 is an enlarged front view of the distal end of a slat component of the apparatus according to an another embodiment of the apparatus of this disclosure, showing another possible means for attaching a clip-hoop thereto;

FIG. 13 is a side, partially sectional view, of the slat component shown in FIG. 12;

FIG. 14A is an end, partially sectional, diagram view of yet another alternative, motorized embodiment of the blind apparatus according to this disclosure, with the slats shown deployed from the base, similar in some respects to the depiction in FIG. 8;

FIG. 14B is an axial cross section of the motor shaft component of the apparatus shown in FIG. 14A;

FIG. 14C is a side view of a bottom or proximal portion of a driven lead slat component of the apparatus shown in FIG. 14A; and

FIG. 14D is a side view of a bottom or proximal portion of a passive slat component of the apparatus shown in FIG. 14A.

Like label numerals are used to identify like elements throughout the drawings. The drawings are intended to illustrate a preferred embodiment of the invention, but do not limit the invention.

### SUMMARY OF THE INVENTION

There is disclosed hereby a window blind suitable for use in arch-type and semi-circle windows, including windows having a curved side defined by a radius, including irregularly shaped windows having a curved side with a varying radius. The apparatus is designed to provide both privacy and shade, and may also be opened easily to enjoy the view and sunlight, through the use of movable solid material blinds. A plurality of slats is pivotal in relation to a mounting base, and can be deployed into an array somewhat suggestive of a common paper-and-slat hand-held fan; the present apparatus ordinarily is much larger than a collapsible fan, however, and serves a wholly different function. While it is contemplated that the apparatus disclosed hereby will find primary use within the windows of buildings, particularly residential homes, the principles of the invention may find utility in other applications were it is desired to regulate the covering and uncovering of an aperture having an irregularly or non-uniformly curved side or border.

Throughout this disclosure, it is contemplated that the window (or other aperture into which the apparatus is to be installed for use) is a generally semi-circular window. The window may be truly semicircular, that is, the window's edges or periphery is defined by one straight-line side (such as the diameter of a circle) and a uniformly curved side (i.e., the semicircle whose radius originates at the mid-point of the circle's diameter). However, a deliberate advantage of the apparatus is its adaptability for use in windows not truly semicircular. Such a window may have, for example, a periphery including a “flat” or straight-line side that is not on the diameter of the circle describing the arcuate curve defining the remainder of the window periphery—that is, the curved portion of the periphery may have a uniform radius, but is an arc of less (or perhaps even greater) than 180 degrees. Alternatively, the window may have a straight-line side with a curved portion of the periphery being other than an arc of a circle, e.g., a segment of an ellipse, parabola, or any other irregular curve, including any of a wide assortment of arches. According to one preferred embodiment, the apparatus can be adjusted to cover elegantly a practically infinite variety of generally arch-shaped windows, including arches that are bilaterally asymmetrical.

The apparatus features in one preferred embodiment a mounting base, which serves as the foundation for the complete apparatus. The mounting base typically is generally rectilinear, so to be suited for fastened attachment (as by mounting brackets and screws, or the like) to the “flat” or straight side of an arched or roughly semi-circular window. However, an apparatus within the scope of our invention could be configured with a curved mounting base, or even a rectilinear, but angled, mounting base, for installation in particular situations or to adapt to oddly-shaped window openings. Further, while typically only one mounting base per window is required to be installed to practice the invention, more than one mounting base could appropriately be called for in special installations without departing from the scope of our invention.

The other principal components of the apparatus are a plurality of slats which are pivotally attached to the mounting base. The slats are grouped into clusters, whereby a plurality of slats in a cluster is pivotable about a commonly shared point of attachment to the base. A particular embodiment of the apparatus may have one or more clusters of slats, although two clusters ordinarily are preferred. Any number of slats greater than two may be deployed, depending on the width of individual slats in a particular embodiment and the size of the window to be covered, although a typical cluster may have five to twelve slats (by way of example, not limitation). The slats in a cluster are separately pivotable, about the axis of common attachment, through angles of rotation. Thus, the slats of a group can be swiveled into a fan-like array spanning all or a portion of the window, and can also be pivotally collapsed into a mutually co-parallel relation to be in a “closed” condition (i.e., to completely uncover the window).

A further advantageous feature of one embodiment of the apparatus is that some or all the slats have adjustable axial lengths. Thus, the longitudinal dimension of a given slat may be adjustable independently of the length of any other bade, including adjacent slats, to permit the shape of the apparatus when opened to be closely adapted to the shape of the window opening. In alternative embodiments, a template is used to customize the respective lengths of the individual slats, such that each individual slat has a fixed length, and the plurality of slats are so arranged, such that when the apparatus is opened the slats deploy to define a covering shape customized to the size and shape of the window.

Spring-assisted and motorized embodiments also are presented as options to the basics of the apparatus disclosed hereinafter.

### DETAILED DESCRIPTION OF THE INVENTION (INCLUDING BEST MODE FOR PRACTICING THE INVENTION)

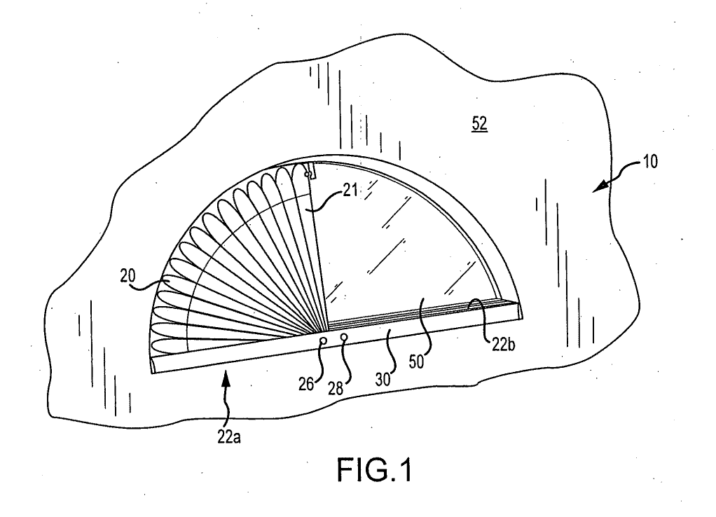

Attention is now invited to the drawing figures, in which like label numerals identify the same or similar apparatus elements throughout the various views. The blind apparatus 10 seen in a basic embodiment in FIG. 1 features two groups or clusters 22a, 22b of oblong slats 20 movably mounted to a base 30. Each cluster of slats 20 is movable to a “window closed” position, in which the plurality of slats in the cluster deploys through an arc of, for example, 90 degrees, more or less, to cover about one-half of a semi-circular window 50. The window 50 seen in FIG. 1 is for typical illustration, about semi-circular, and is mounted in a window casing within a wall 52 in any conventional manner using window seals, etc. Each cluster 22a, 22b may also be collapsed down through the arc (e.g., 90 degrees) to a “window open” position, in which position the slats are aligned in a row adjacent the base 30, and one-half of the window 50 thus is not covered by the apparatus. In FIG. 1, it is seen (viewed from inside the building) that a first or left-hand cluster 22a of slats is deployed to the “window closed” position, while the second or right-hand cluster 22b is retracted into the base 30 in a “window open” condition. In a preferred embodiment, the pair of clusters of slats 20 is situated in a supplementary manner on the base 30, so that when both clusters 22a, 22b are deployed to the window closed position, the entirety 180-degree arc of a semicircular window is covered by the apparatus. Referring still to FIG. 1, it is seen that the left-hand side of the window is covered by one cluster 22a of slats 20 deployed in the window closed position, while the right-hand side of the window remains uncovered because the other cluster 22b is stowed in the trough-like base 30. Again, however, both clusters 22a, 22b of slats can be concurrently disposed in either the window open or the window closed condition.

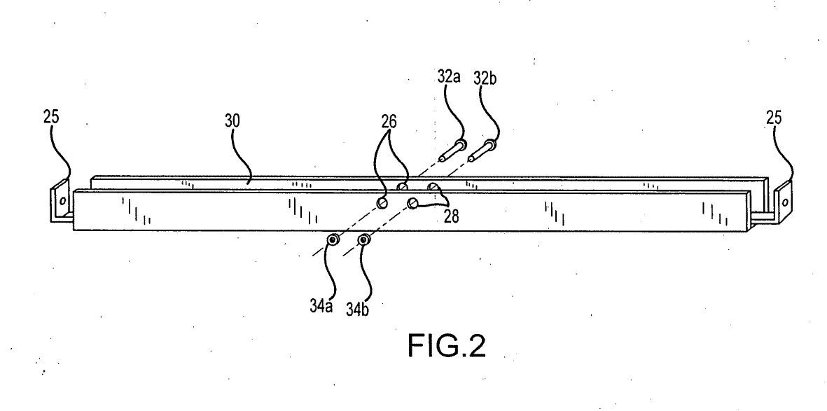

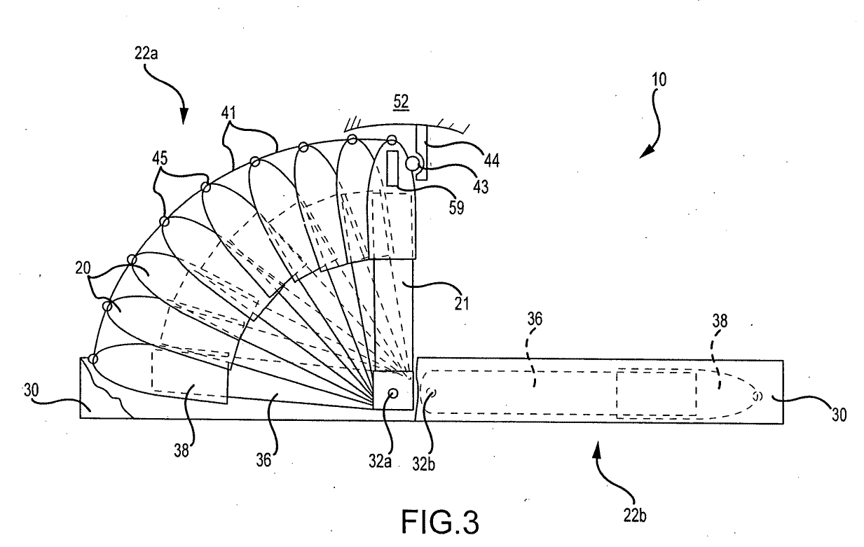

The present blind apparatus 10 thus features in a preferred embodiment a bilateral “split” fanlike design (a left side and a right side), as seen in FIGS. 1 and 3. Referring to FIGS. 1 and 3 jointly, each “fan” of the blind 10 is a cluster 22a or 22b of a plurality of oblong slats 20 attached to the mounting base 30. The mounting base 30 may be fastened to the base of the arched window 50 (FIG. 1) using screws or the like. In the event the arched window 50 is at the immediate top of a square/rectangle window, the ends of the base 30 may be attached to the interior (e.g., typically vertical) sides of the window casing using mounting brackets 25, shown in FIG. 2 as extending any suitable or adjustable distance from each end of the base 30. The drawing FIG. 1 shows the apparatus 10 installed with the mounting base 30 at the bottom of a semi-circular window 50. However, it is immediately understood that the base 30 could be installed in a vertical orientation in a window having a vertical flat side, or could be attached to the top flat side of a semicircular window whose curved side faces downward, or in other positions relative to vertical and horizontal.

In geometry, and as used herein; an “arc” is a closed segment of a differentiable curve in the two-dimensional plane; for example, a circular arc is a segment of the circumference of a circle. The arcs through which the slats 20 of each cluster 22a or 22b may move are any curved arc, not limited to circular arcs. And the arcs of movement, for the slats in a pair of clusters sharing a common base, preferably are substantially co-planar (taking into account that the clusters are three-dimensional, and have a front-to-back dimension whether in the retracted first position adjacent the base 30 or in the deployed second position, creating the fan-like arrangement of progressively overlapping slats seen on the left side of FIG. 1).

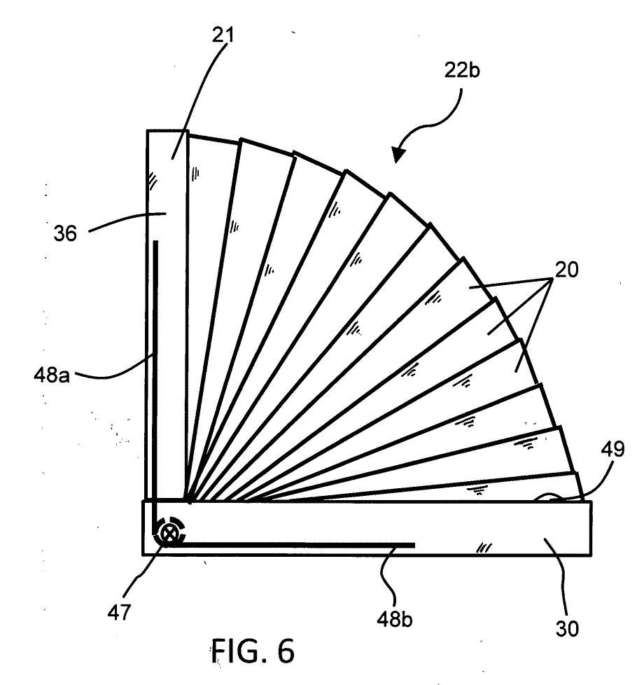

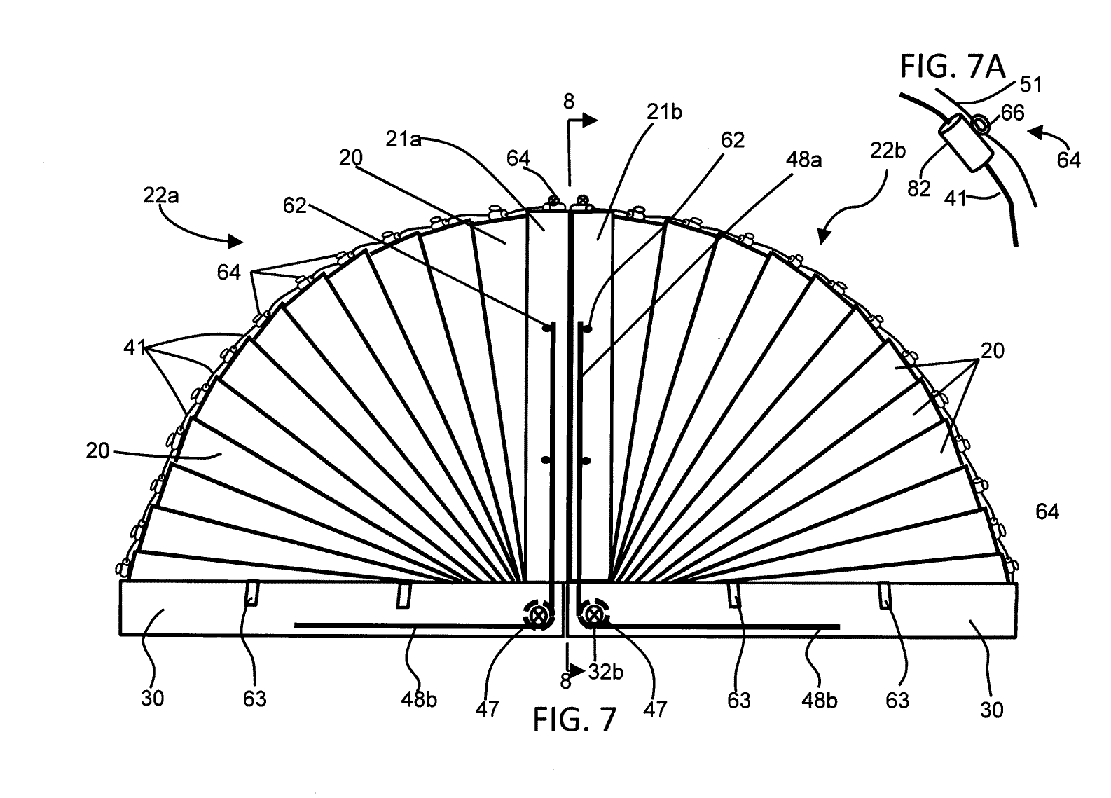

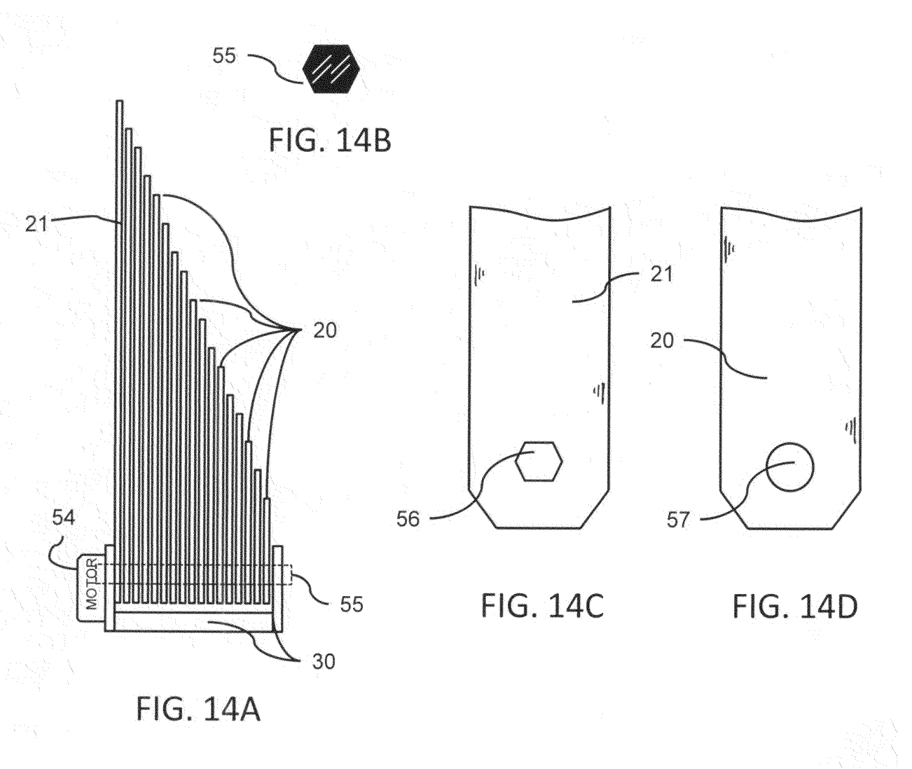

There are disclosed hereafter variations of the blind's configuration and function. For example, the apparatus in its simplest configuration is operated manually, utilizing a pull knob 59 and a magnetic (or other) releasable catch assembly 43, 44 (FIG. 3). Alternatively, the apparatus can be manually operated using the pull knob 59 but with a torsion spring assist FIG. 7-9. Or, in yet a further embodiment, the apparatus can be automated, utilizing a direct motor drive 54, 55 (FIGS. 14A-D).

In preferred embodiments, the base 30 is a lightweight trough-shaped component, having a floor with two opposing sides extending upwardly there-from, as best seen in FIGS. 2 and 7A. The base 30 may be fabricated by known methods from plastic, aluminum, wood, or any other suitable relatively rigid material. The exterior of the base 30 may be provided with an aesthetic finish and be of a selected decor-matching color.

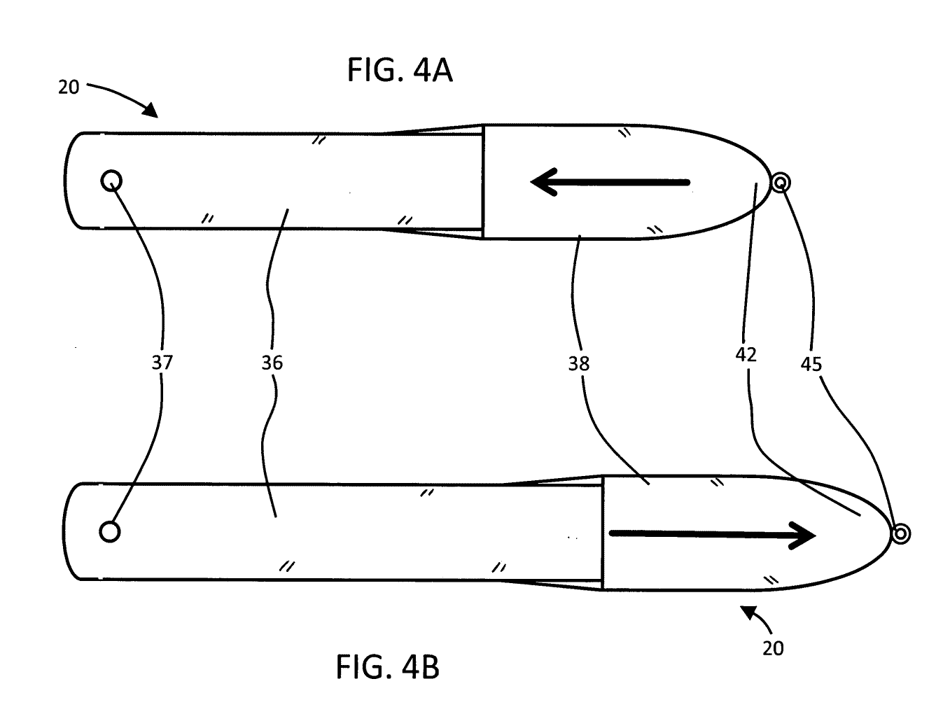

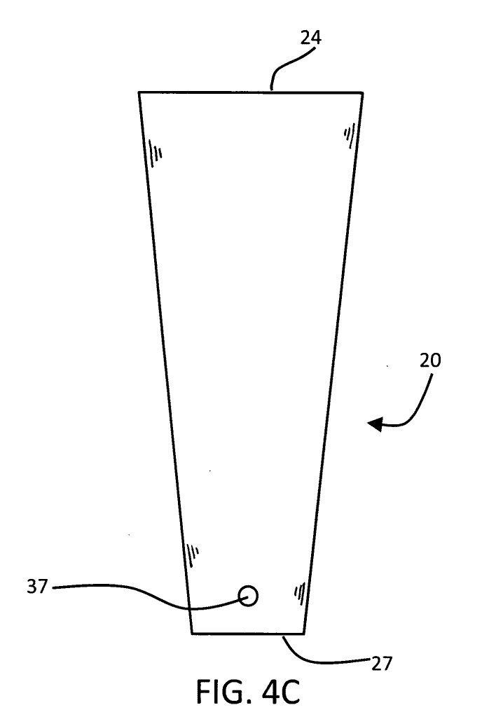

As illustrated in FIGS. 1 and 2, the mounting base 30 preferably has two pivot axes defined by pivot apertures 26, 28 penetrating both sides of the base laterally very near (e.g., but on opposite sides of) the base's longitudinal midpoint. A first pair of apertures 26 is in axial registration, and a second pair of apertures 28 is in axial registration, through opposite sides of the base 30 as seen in FIG. 2. As indicated in FIGS. 1-3, the proximate ends of the slats 20 are pivotally attached to the base 30 by means of small dowels, bolts, or other pivot pins 32a, 32b. each pivot pin 32a or 32b is inserted through one side of the base 30 at a corresponding pivot aperture (26 or 28), sequentially through a corresponding pivot pin aperture 37 (FIGS. 4A and 4B) in the proximate end of each slat 20 in the cluster, and then exiting through the other side of the base, to be fastened with a nut 34a, 34b or the like. The pins 32a, 32b accordingly each functions as a pivot axle, about which an associated cluster 22a or 22b of blind slats may pivotally swing, the proximate ends of the slats being rotatably mounted on the pins. Other equivalent modes of providing pivot axles may be employed without departing from the scope of the invention; it is needed simply that the proximate ends of the clustered slats 20 be maintained in pivotal co-registration, leaving the distal ends of the slats to swing through an arc whose vertex is at the axle. In sum, the holes 37 in the proximate ends of the slats 20 of a cluster can be aligned, and placed in registration with both pivot apertures (e.g., 26) defining a pivot axis, thus not only attaching the cluster (e.g., 22a) of slats to the base 30, but also permitting the slats to pivot about the common axis defined by the shared pin (e.g., 32a).

In the preferred embodiment, there is a left-side cluster 22a of slats movably disposed on a left-hand pivot pin 32a and a second, right-side, cluster 22b separately and movably disposed on a second or right-side pivot pin 32b disposed through a separate pair of pivot apertures 28 in the base 30. Providing two separate clusters 22a, 22b of slats allows each side of the fan-like blind 10 to be independently disposed in either the window closed position seen on the left side of FIG. 1, or the window open position as seen with the right-side cluster 22b in FIGS. 1 and 3. One slat cluster 22a can be placed in the open or closed position independently of the other cluster 22b. Thus, each of the side clusters of slats can deploy into a “window closed” position in which the slats span an approximately ninety-degree arc, so that when both clusters are in such a condition, the 180 degrees of a semicircular (or other arch-shaped) window 50 are covered. Or, both slat clusters can be retracted to the “window open” position, where all the slats of the cluster are drawn into parallel registration within, or parallel adjacency to, the base 30, so that the full span of the window 50 is uncovered.

In addition to the benefit of independently adjustable side clusters of the blind 10, this preferred design also reduces the lateral bulk at the pivot points by about 50%, compared to having all the slats 20 (to cover a full semi-circle) attached at a single pivot axis or axle. This allows the apparatus (more particularly the base 30) to have a cosmetically narrower lateral thickness (i.e., front-to-back in FIGS. 1 and 2), and concomitantly shorter pivot pins, while yet allowing a suitably sized blind 10 to be effectively installed in a relatively large window 50. In contrast to any design in which all the slats 20 are pivotal about a single pin to open and close through a full 180-degree arc, the present paired “split-fan” design permits the apparatus 10 advantageously to occupy a more modest “footprint” within the window or other aperture.

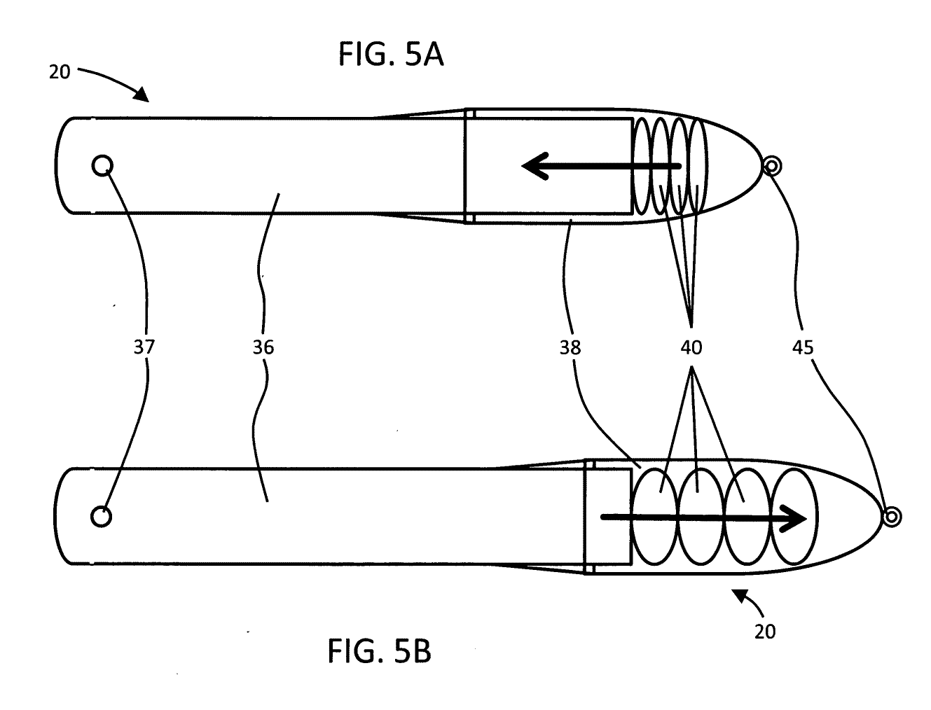

Specific attention is invited to FIGS. 4A-5B, showing additional details of a preferred construction of individual slats 20 of the disclosed blind apparatus 10. Each slat 20 is thin relative to its length and width and is oblong in shape, being roughly rectangular in side view shape throughout a majority of its longitudinal dimension. However, the distal end of each slat 20 optionally features a curved or oval-shaped tip 42, perhaps reminiscent of a flower petal, as seen in the figures. However, the distal tip of a slat can any of a variety of other shapes, including the flat tip 24 seen in FIG. 4C. A slat 20 has a pivot pin aperture 37 in the proximal end of its base slat 36, through which respective pivot pins 32a, 32b (FIG. 2) are inserted. Each blind slat 20 is configured to assume automatically a compressed position (as seen in FIGS. 4A and 5A) or extended position (as seen in FIGS. 4B and 5B) to accommodate an irregular or non-uniform shape, e.g., a parabolic curve, segment of a semicircle, or custom arch, of the window 50. As shall immediately be described further, each slat 20 preferably is devised to collapse longitudinally in response to a force applied axially against its distal tip 42, as a distal sleeve 38 retracts to temporarily foreshorten the slat's overall length.

Thus, a slat 20 or 21 may be configured in any of a wide variety of shapes and sizes, according to the window size and shape in which the apparatus 10 is to be installed, the desired aesthetics of the slats, manufacturing costs, and the like. For example, it may be desired, optionally, to fabricate the slats 20 in an elongated trapezoidal shape, in which the slat 20 has a broad distal end 24, with side edges converging toward a proximal pivot end 27 that is shorter in width than the distal end 27. Slats having the tapered shape in FIG. 4C offer an efficiency advantage; a relatively fewer number of slats 20 are required (compared to, say, rectangular slats) to cover a given arc sector of a window with a deployed cluster of slats. Fewer slats 20 means a narrower, trimmer, apparatus (front to back in the window opening), and a less complicated and expensive manufacture. Further, the slats 20, 21 may be crafted from an acceptably rigid or semi-rigid material; depending on the particular embodiment, the slats may be composed of, for example, plastic, aluminum or other lightweight metallic alloy, or wood.

FIGS. 4A and 4B, and especially FIGS. 5A and 5B, illustrate that each slat 20 is composed of three main parts—the flat base slat 36, the flat distal sleeve 38 which slides over the distal end of the base slat, and a spring 40. The cap-like sleeve 38 is slidable axially in relation to the base slat 36. The spring 40 is contained within the interior of the distal sleeve 38, between the distal end of the base slat 36 and the sleeve. The spring 40 may be a multiple “S” type or similar, or otherwise suitable type, of compression spring which is inserted within the sleeve 38 prior to its installation over the base slat 36. The spring 40 is resiliently compressible between the distal end of the base slat 36 and the inside of the distal end of the sleeve 38. Thus, when the spring 40 is in the uncompressed “rest” condition seen in FIGS. 4B and 5B, the slat 20 rests at its normal condition of maximum length. However, if an axial force is applied inward to the exterior of the distal tip 42 of the sleeve 38 (as by the affect of being pressed against the inside surface of a window casing), the sleeve slides axially inward, against the force of the compressing spring 40, to any one of a number of possible compressed positions. Thus the effective length of a slat 20 is adjustable infinitely incrementally to accommodate the precise window configuration at the slat's particular installation location. The spring 40 causes the sleeve 38, and ultimately the slat 20, to be collapsible or expandable, depending upon the amount of force/resistance being applied as the blind 10 travels in the opening of the window frame.

With particular reference to FIGS. 5A and 5B, there is disclosed that a preferred form of each slat 20 has the distal sleeve 38 in overlapping sliding engagement with the base slat 36. As suggested by the drawing figures, the sleeve may define in profile a somewhat ovoid, leaf-like shape or some other contoured shape, whereby added interior space is provided within the interior of the sleeve 38 to help accommodate any outward lateral expansion of spring 40 when it is compressed (as in FIG. 5A). Such shaping of the sleeve 38 also may also beneficially improve the visual aesthetic of the slat 20. The distal end of the sleeve 38 preferably symmetrical curved edges that converge at the tip 42. The tip 42 of each sleeve optionally may mount a free-wheeling roller 45, as discussed further hereinafter.

The sleeve 38 is essentially hollow with interior lateral and vertical dimensions just greater than the corresponding exterior dimensions of the distal portions of the base slat 38. Accordingly, as suggested by FIGS. 5A and 5B, the sleeve 38 functions in the manner of a “scabbard” for the “sword” of the slat 36. As suggested by the directional arrows of FIGS. 4A and 4B, the sleeve 38 can slide to-and-fro axially upon the slat 36, but is constrained against any other movement by its enveloping engagement with the slat 36. The spring 40 is situated within the interior of the sleeve 38, and is contactable with the distal end of the slat 36 within the sleeve. Thus, and again as indicated by FIGS. 5A and 5B, the sleeve 38 can reciprocate against and from the force of the spring 40. The sleeve 38 can slide toward the slat's pivot axis by compressing the spring (as indicated by the directional arrow in FIG. 5A) within the sleeve. If the axial force on the sleeve 38 is released, the action of the spring 40 slides the sleeve axially, extending the effective length of the slat 20 until the sleeve attains its rest position with the spring uncompressed. Optionally, the distal end of the spring 40 may be connected to the sleeve 38, and/or the proximate spring end may be connected to the distal end of the base slat 36.

FIG. 1 illustrates how the plurality of slats 20 in a cluster 22a thus each extends in length until its distal tip 42 contacts the window casing interior, permitting the blind 10 automatically to assume a general correspondence in size and shape to the window 50. Of course, the user at the time of installation ideally selects a particular model or embodiment of the apparatus 10 having slats 20 of maximum rest length no less than the approximate maximum radius of the window 50, so that the slat tips will contact, or nearly contact, the window casing when the slat clusters 22a, 22b are swung into the window closed position.

An additional benefit to this collapsible/expandable feature of the slats 20 of the blind 10 is the elimination of the need for a template to build a blind with the correct varying length slats, especially when the window 50 has a non-uniform curvature. The presently disclosed design requires only two measurements (as is also true for blinds designed for square/rectangular windows)—the width at the straight-line or “flat” base of the arched window 50, and the maximum height (analogous to a “maximum radius”) at the center of the arch. The apparatus 10 is configured so that the extended or “rest” position of the slats 20—that is, when the spring 40 is uncompressed—is approximately equal to or preferably slightly greater than (e.g., about 0.5 cm extra) to the maximum height/radius of the window to be covered.

However, the blind apparatus according to the present disclosure alternatively may be constructed using slats 20 of fixed lengths. In such instances, the dimensions of the window opening 50 are carefully measured and a template created to duplicate the window size and shape. The template then is used to fabricate slat clusters custom-fit to the window opening. Using the template, the fixed length of each slat 20, and its relative position within its cluster 22a or 22b, is carefully determined. The slats 20, each of which may have a slightly different length compared to its neighboring slat(s), are then selectively arranged according to proper order (according to length) in a collapsible array as suggested in the drawing figures, and pivotally fixed using the pivot pins 32a, 32b, as previously explained. When such a cluster is deployed to the window closed position, each slat 20 swings to a location at which its length approximates (slightly less) the radius of the window 50 at that location.

As indicated in FIG. 3, each slat 20 may be flexibly attached, as by a selected length of fine twine, light ball chain or other fine chain, polymer line 41, or the like, to its neighboring slat(s). Attachment preferably is at or near the respective distal or outer tip ends 42 (i.e., furthest from the pivot point). This flexible cord connection causes each slat 20 to “follow” the slat immediately preceding it when the slat cluster 22a, 22b of the blind 10 is being moved between its collapsed, “window open” condition and the “window closed” position. When the blind is being closed by the collapse of the slats 20, the flexible connector 41 between the slats 20 pulls the slats to their resting position in the mounting base 30.

The flexible connector cords 41 preferably are connected near the distal end of each slat 20, but alternatively may be attached to an intermediate portion of each slat. As described in added detail hereinafter, they can be connected, for example, at the outer edge end of each sleeve 38, where there may be disposed a clip insert or clip cap, connectable with an associated clip lock, to attach a cord or ball chain to the sleeve 38 or slat 20. A clip insert is inserted into a groove machined into the sleeve 38 (or slat 36), while a clip cap is slipped over the end of the sleeve 38 and requires no machining of the sleeve.

Continuing reference to FIG. 3, the leading-edge slat 21 for each of the two sides of the blind apparatus 10, at both the right side and the left side slat clusters, preferably has a releasable fastener 43, such as a magnet or other similar releasable fastener attached near the outer edge (distant from the pivot axis), which engages with a corresponding magnet or receiving bracket 44 attached to the wall or window case 52 at or near the apex of the window opening. The fasteners 43, 44 are complementary, such as attractive magnets, snap-engagement connectors, hook-and-loop fabric fasteners, or the like, so that when the user brings the leading slat 21 to the fully deployed position as seen in FIG. 3, the fasteners temporarily and releasably engage to maintain the cluster of slats in the deployed “window closed” position shown in FIG. 1. Fasteners 43, 44 can be disengaged by a gentle but sudden pull or jerk, so that the lead slat 21 is freed from connection with the fixed fastener 44, and the slat cluster (e.g., 22a) is fully pivotal about its corresponding axis, and can be stowed into the base 30.

The use of fasteners 43, 44 is optional in spring-assisted or automated motorized versions of the apparatus disclosed herein below. In these alternative embodiments, a spring or a motor shaft, in operable engagement with a lead slat 21 of a cluster of slats, maintains the lead slat in a deployed position and the need for complementary fasteners 43, 44 is ameliorated or eliminated.

The lead slat 21 of each cluster also preferably mounts near its distal end a pull knob 59 by which the lead blind may be grasped and manually pulled between the window closed and the window open positions. In the event the window 50 as at an elevated height out of convenient reach of a user, an extension rod having a looped or hooked distal end may be provided, which is removably and controllably engageable with the pull knob 59 to permit the blind 10 to be operated by a user standing on the floor. Alternatively, a pull cord can be attached to the pull knob 59 to have an end hang to a convenient height for operating the apparatus.

As best seen in FIGS. 4A through 5B, the distal tip 42 of each slat 20 may be provided with a roller or glide 45, which travels against the perimeter of the window opening when the blind 10 is operated, i.e., either being opened or being closed. A roller 45 can be a small, axle-mounted wheel, a pin bearing, or a smooth glide of any known suitable type. The roller 45 preferably is fabricated from a resilient polymer, so that it can frictionally roll or slide along the inside of the window casing without marring the casing surface. As the roller/slide 45 travels against the perimeter of the opening, the slat 20 is designed to shorten axially (by the sliding of the sleeve 38 in relation to the base slat 36 and against the spring 40) as it encounters pressure, and also to extend as it encounters less pressure, thereby adapting to the dimensional irregularities of the window periphery. A user optionally may install a smooth liner (not shown) in the perimeter of the window opening to facilitate smoother operation in the event the perimeter has a rough or uneven surface. The use of rollers 45 is indicated mainly with a manually-operated embodiment of the blind apparatus 10 according to the present disclosure, and especially in which the slats 20 enjoy the length auto-adjust feature provided by the moveable sleeves 38. In embodiments in which a distal sleeve 38 is pressed into contact with the window casing, the rollers 45 promote the smooth movement of the slat tips past the window periphery.

FIG. 6 illustrates an alternative embodiment of the apparatus 10. For quarter-circle windows, a shorter base (i.e., either the “right half” or “left half”, a single right side shown in the figure), and one single cluster of slats is employed. A single cluster of slats 20 is shown, as might be used in an embodiment adapted to cover a 90-degree arc (quarter-circle) type window, but it shall be immediately understood—and as discussed further hereinafter—that the “spring-assist” principles of this embodiment are readily applicable to a blind 10 suited to a semi-circular or other irregularly-shaped window opening. Thus the version seen in FIG. 6 is operable with the assistance of a torsion spring 47, but a quarter-circle embodiment of the apparatus alternatively could be manually operated, or motorized, according to disclosures elsewhere herein. The configuration and function of this embodiment thus is similar to those previously described above, except as here noted and seen in FIG. 6. A quarter-circle embodiment may, but not necessarily, have slats of automatically adjustable length, using the spring 40 and sleeve 38 configuration described previously. It is noted from FIG. 6 that the slats 20 optionally may feature flat, blunt, distal ends, rather than pointed tips, according to a desired aesthetic.

The deployment of the cluster 22 is aided by the action of a conventional spiral or other type torsion spring. 47. In this spring-loaded embodiment, the torsion spring 47 is situated having a first one of its operative arms 48a attached to or engaged with the lead slat 21, and its second operative arm 48b attached to or engaged with the base 30. The axis of the coiled body of the spring 47 preferably is about coaxial with the pivot axis of the cluster as defined generally by a pivot pin 32b. The torsion of the spring 47 is such that it tends to deploy the cluster of slats 20 from a stowed position on the base 30 to the “window closed” condition seen in FIG. 6. In the case of a split-fan embodiment (such as in FIG. 3), a “left-hand” torsion spring is used in the left half cluster 22a, and a “right-hand” torsion spring is used for the right half cluster 22b (i.e., it is understood that the slats pivot in opposite rotational directions, under the force of their respective springs on the opposing sides of a two-cluster type blind 10. The default or resting position for this embodiment is the “window closed” position seen in FIGS. 1 and 6. The slat cluster is moved the stowed “window open” position by collapsing it against the force of the spring 47 (as indicated by the directional arrow in FIG. 6), until the slats 20 are mutually parallel and adjacent the base 30, where they can be held in place by a pivotal lockbar 49 or other suitable means.

FIGS. 7-9 are more involved illustrations of the torsion spring-assisted embodiment of the apparatus, in which the spring-assist option is adapted into a tandem-cluster version of the blind apparatus 10. FIG. 7 shows a pair of slat clusters. The left-side cluster 22a in FIG. 7 has moved clockwise in the figure, from a retracted position in the left-hand side of the base 30, to the fully deployed position seen in the figure; in the deployed position, the lead slat 21a is substantially vertical, at about a 90-degree angle with respect to the base. As has been described previously, the slat cluster 22b likewise is movable counter-clockwise from the second or deployed position in the figure to a first retracted position, in which it is substantially concealed within the trough-shaped base 30. The right-side cluster 22b also is shown in the deployed position, but pivots oppositely from the left-side 22a cluster in the sense that it has moved counter-clockwise in the figure from the retracted “window open” position, to the second “window closed” position seen in the figure (with its lead slat 21b substantially parallel and proximate to, or in contact with, the other lead slat 21a). The cluster 22b is movable clockwise from the position seen in the figure, through an arc of about 90 degrees, to the retracted first position, e.g., concealed within the base 30. As apparent from previous discussion herein, the slats of other tandem-cluster embodiments of the apparatus are similarly movable.

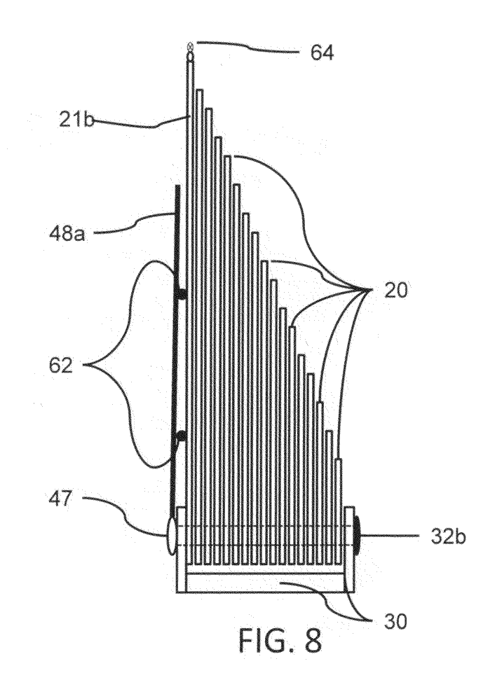

FIG. 8 is a sectional view of the spring-assisted embodiment of FIG. 7, taken in a vertical plane at the longitudinal middle of the apparatus. The figure illustrates the pivotal attachment of the plurality of slats 20 to the base 30 by means of the pivot pin 32b. The slats 20, 21 of the cluster are viewed “on end” in the deployed position. As mentioned previously, they movable through an arc (perpendicular to the paper in FIG. 8) between a first position in which the slats are retracted in parallel proximity to the base 30, and a second position in which the slats are deployed in a progressively overlapping arrangement covering a sector of the arc having its vertex at the cluster's pivot axis (at about the pivot pin 32b), in which the arc sectors of deployed slat clusters 22a, 22b are substantially coplanar. By “substantially” in this context we mean taking account of the overlapping disposition of the proximal portions of the slats 20, 21 of each cluster as illustrated in FIG. 8, which prevents the salts from being strictly coplanar in the true geometric sense of the word. Each cluster of slats will have a modest front-to-back dimension (right-to-left in FIG. 8) that prevents the slats from being situated within a single two-dimensional plane, but one skilled in the art shall understand that the clusters 22a,22b in a tandem-cluster blind 10 will be in a conceptually co-planar registration as suggested by FIG. 7.

Combined reference is made to FIGS. 7 and 8. To facilitate proper assembly and smooth operation of the spring-assisted blind apparatus, each of the lead slats 21a, 21b, is provided with at least one, or preferably two, or more stand-offs 62 which project a very modest distance from the back side of the lead slats. The stand-offs 62 which may be pin-like in configuration as suggested by the figures, provide receiving surfaces against which the operative arms 48a of the respective torsion springs 47 may press to move a corresponding slat cluster 22a or 22b. Engagement between each of the lead slats 21a and 21b and a corresponding one of the torsions springs 47 thus is provided by the stand-offs; a spring arm 48a may be connected to a particular stand-off, or simply press directly against it by the compressive force of the spring 47. The other operative arms 48b are engaged with, as by attachment or spring bias, the base 30 as previously described. The stand-offs 62 thus accommodate the position of the operative arm 48a in relation to both the lead slats 21a or 21b, and the coiled main body of the spring 47—the arm 48a being offset somewhat from both. Slots 63 may be provided at appropriate corresponding locations in the back wall of a trough-like base 30, as needed, to accommodate the stand-offs 62 when the lead slats 21a, 21b are retracted into the base when the slat cluster is in the “window open” position.

Combined reference is made to FIGS. 7-9, illustrating in further detail the provision and disposition of the flexible connectors 41 which extend between neighboring slats in a cluster. In one preferred embodiment, the distal end of each slat 20, 21 is fitted with a clip-hoop assembly 64 for connecting the flexible connector(s) 41 to the slats. As shown in FIG. 7, a clip-hoop 64 is secured to the distal end (or tip) of each slat 20, 21 by any suitable means, such as with an attachment clip cap or clip insert engaged with a complementary portion of the distal end of the respective slat, or by an adhesive, or the like.

Referring particularly to FIG. 7A, each clip-hoop 64 has a clip portion 65 that is devised and configured to grip or grasp (as by frictional engagement) the flexible connector 41. The clip portion 65 may be, for example, a rigid tube with a detent or clamp device to press the flexible connector 41 within the interior of the clip portion. Or, the inside diameter of the tubular clip portion 65 may be less than the effective maximum diameter of the flexible connector 41 to provide a frictional fit of the connector into the clip portion. Other modes of gripping or locking engagement between the clip portion 65 and the flexible connector 41 may be devised in accordance with the invention; a possible version is discussed further herein below. Affixed to the clip portion 65 in FIG. 7A is a hoop portion 66 (e.g., a circular ring or short circular tube) having a diameter greater than a flexible pull cord, such that the pull cord can slide readily and smoothly through the hoop portion 66.

The clip-hoops 64 are attached to the distal ends of the slats 20, 21 with their axes substantially parallel to the distal edge of the slats, that is, the axes of the clip-hoops are generally tangential to the movement arc of the slats, as suggested in FIG. 7. In most applications, the flexible connector 41 preferably is disposed through the clip portion 65 of each clip-hoop 64 on each slat. (Whether the flexible connector 41 is engaged with the clip portion 65, or slipped through the hoop portion 66 of a particular clip-hoop 64, on a particular slat depends on whether it is desired to have the particular slat securely attached to the flexible connector, or merely slidably engaged with it.)

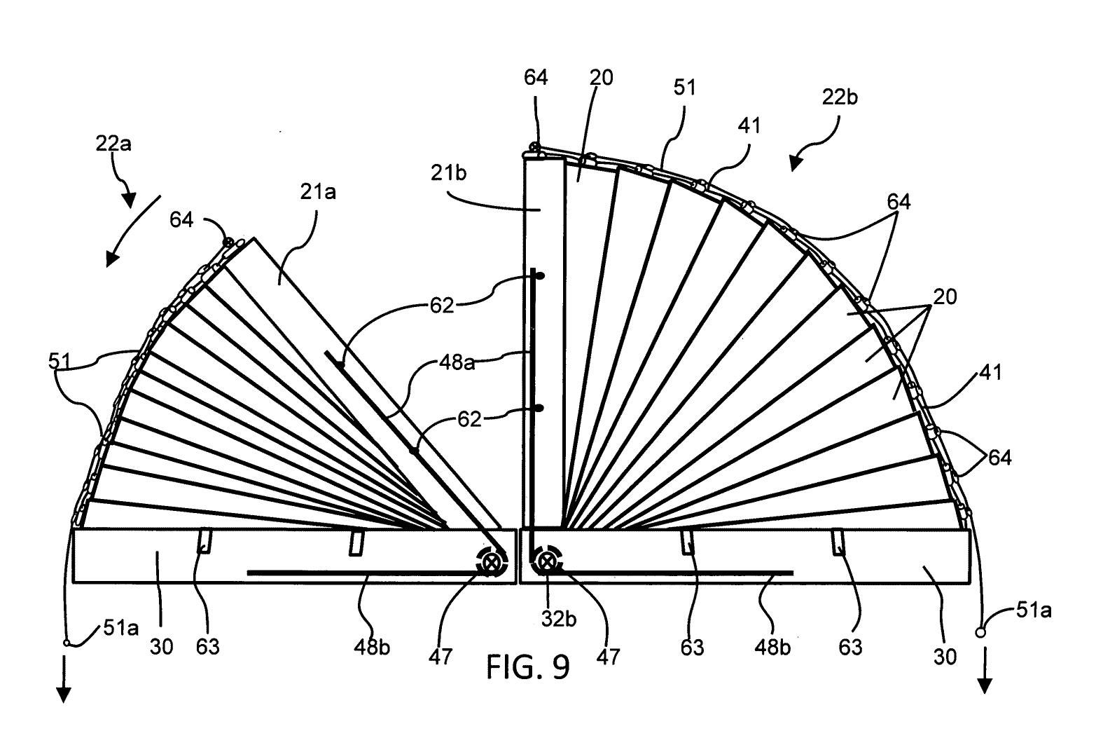

The flexible connector 41 gripped or clamped in the clip portion 65, so that the portion of the connector in the clip-hoop is secured against movement relative to the associated slat. When the connector 41 is engaged in the clip portion 65, the slat cannot move relative to the clip-hoop 64, and movement of the connector 41 will cause corresponding movement of the slat 20 or 21 (i.e., inducing its pivotal movement about its pivot axis). In a spring-assisted embodiments particularly, a flexible pull cord 51 is passed through the hoop portion 66 of all the clip-hoops 64 in a cluster of slats, except that the pull cord 51 is in locked engagement with the clip portion 65 of the clip-hoop 64 on the lead slat 21 of a cluster of slats. Accordingly, the pull cord 51 can be pulled downward to “close” a cluster of salts from the window-closed position to the window open position, as suggested by reference to FIG. 9. (The use of the specialized clip-hoops 64 permits the user to select whether a particular slat 20 has a fixed or slipping connection to the flexible connector 41 (which can be a fine twine, cord, or ball chain, etc.). This permits the function of the apparatus to be customized, as the preferred and pre-determined interaction between the various slats 20, 21 and the flexible connector 41 in a given apparatus may vary depending upon whether the apparatus is manually operated, spring-assisted, or motorized, and according to the user's preferences.)

It should be understood that the flexible cord 41 preferably is employed in all embodiments of the apparatus according to this disclosure, to promote properly aligned and smooth retraction and deployment of the slats 20, 21. Thus, it is preferred that some version of a clip-portion 65 be available and installed on each slat of a blind 10. However, for automated motorized versions of the apparatus particularly, and also for manually operated versions, hoop portions 66 are not absolutely necessary and may be omitted from the clips 64 on the end of each slat. Similarly, the pull cord 51 is optional on most embodiments of the blind apparatus, but is strongly preferred on the spring-assist version seen in FIGS. 7-9. Consequently, spring-assist embodiments of the apparatus preferably also feature hoop portions 66 for guiding and retaining the pull cord 51.

The example of the utility of the flexible connector 41 and pull cord 51, together with the plurality of clip-hoops 64, is provided by further reference to FIGS. 7 and 9. The pull cord 51 of a cluster is slidably disposed through the hoop portions 66 of the clip-hoops on all the slats 20 of either cluster 22a, 22b, except that the distal end of the cord 51 is securely gripped in the clip portion 65 on the end of the lead slat 21. The pull cord 51 can be used to pull either cluster 22a or 22b from the window closed position depicted in FIG. 7, toward and to a second retracted position adjacent the base 30, as suggested by the directional arrows of FIG. 9. The operative connection of the pull cord 51 with a cluster 22a or 22b is at the clip-hoop 64 on the lead slat 21a or 21b, while the sliding movement of the slats 20 relative to the cord 51 is controlled and guided by the cord's passage through the hoop portions 66 on the other slats 20. In FIG. 7 (and similarly in FIG. 3), it is seen that the flexible connector 41, being secured to the distal end of each slat 20, helps maintain the deployed slats in a proper fanned arrangement. The connector 41 inhibits shifting movement of any slat 20 (especially its distal end) in a direction parallel to the slat's pivotal axis (i.e., in a direction perpendicular to the pages of drawing FIGS. 3 and 7).

Accordingly, particularly when the apparatus is the spring-assisted embodiment and/or is situated in a high window, the user may pull the cord 51 against the torsion of the spring 47, from the “window closed” position to the retracted “window open” position. The distal end of the flexible pull cord 51 is in locked engagement with the clip portion of the clip-hoop 64 on the lead slat 21a of the cluster 22a, and the pull cord 51 is threaded through the hoop portions 66 of the clip-hoops 64 on all the other slats 20 in the cluster 22a, so that those slats 20 can slip and slide along the pull cord 51 (FIG. 7A). Again referring to FIG. 9, a proximate end 51a of the pull cord, which may be permitted to dangle a considerable distance downward below the blind apparatus, can be grasped by a user and pulled to “open” the blind. As the user pulls down on the pull cord, the pull cord pulls against the force of the torsion spring 47, and causes the lead slat 21a to pivot down and away from its vertical deployed position. Referring still to FIG. 9, continued pulling on the pull cord pivots the lead slat 21a toward the first or fully retracted position, where it is brought into parallel adjacency with the base 30 (see, for example, the right-hand side of FIG. 3), where it can be held in place by a simply retractable pivot bar or lock 49. Because the other slats 20 have slipped engagement with their respective clip-hoops 64, they are free to fall into retracted position near the base 30 by the actions of the descending lead slat 21 and gravity. The retraction action is possible despite the connector cord 41 having a fixed connection to each slat 20; the inelastic flexible nature of the connector 41 permits it to buckle freely as needed to allow a cluster of slats to retract. On the other hand, the pull cord 51 can sustain a beneficial tension force, permitting it to pull each slat along in a serial manner to deploy or retract a cluster, in an instance of the apparatus in which the connector cord has a fixed connection to the distal end of each slat.

Thus, when the pull cord 51 is pulled in a downward direction by the user, it may be locked in any position by securing the cord 51; similarly, the cord may be released to reposition the blind (like a standard corded blind operation). Any downward force on the cord end 51a moves the lead slat 21 toward a horizontal (window open) position, along with each of the slats 20 in turn. The blind is closed by releasing the pull cord 51, allowing the torsion spring 47 to return the lead slat 21, along with each of the other slats 20 that follow, to the vertical (window closed) position.

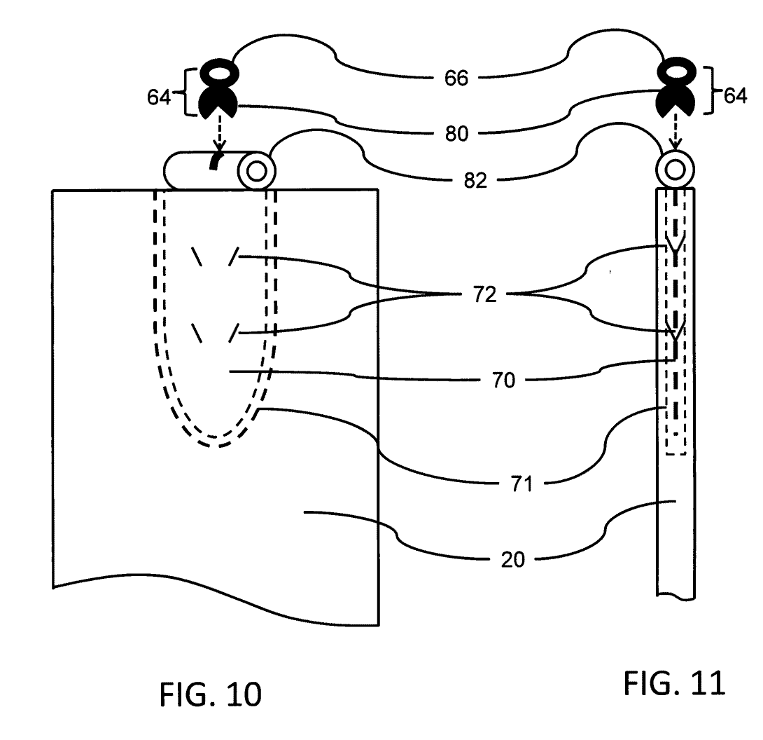

FIGS. 10 and 11 show one mode by which a clip-hoop 64 may be attached to the distal end of a slat 20 or 21, and a possible configuration and function of the clip portion 65. In this alternative, the clip-hoop 54 is fixed upon a thin, generally rigid, flat insert tab 70. There is a tab slot 71 machined longitudinally into the distal end of the slat 20. The size and shape of the tab slot 71 correspond generally (but are very slightly larger) than the size and shape of the insert tab 70. Thus, the insert tab 70 is insertable into the slot 71, to provide a reliable frictional engagement between the tab and the slat 20. The engagement may be fixed with an adhesive, if desired. It may be preferred to provide for a snug and reliable, yet releasable, frictional engagement only, however, to permit facile removal of a damaged clip-hoop 64 and insertion of a replacement clip-hoop. The reliability of the engagement optionally is enhanced with barbs 72 (of light wire, stiff plastic, or the like) extending from the insert tab 70 in a directional manner that allows for simple insertion of the tab 70 into the slot 71, but which resists inadvertent removable of the tab 70, as suggested in FIGS. 10 and 11.

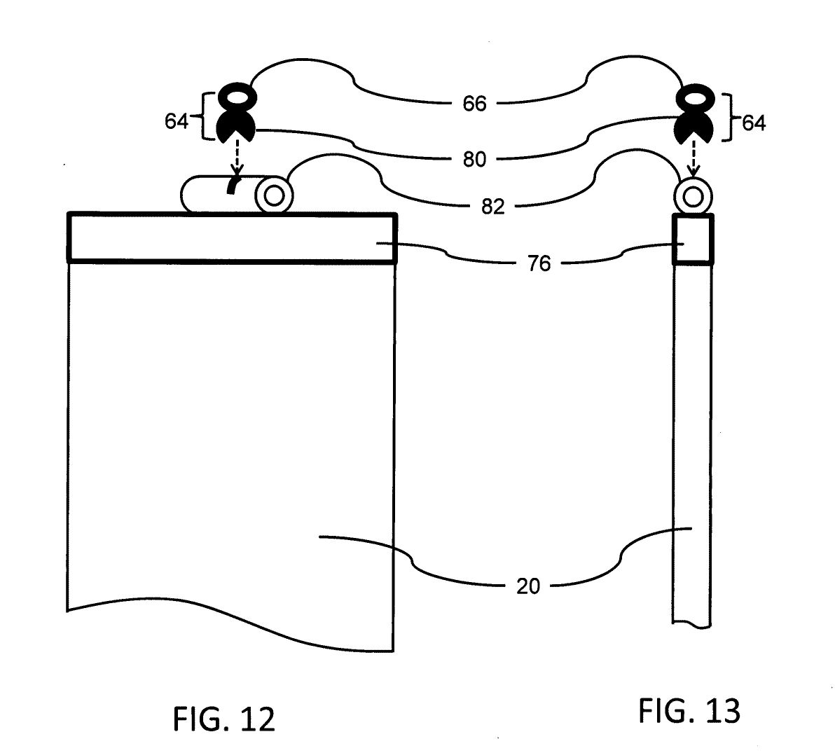

Alternatively, as seen in FIGS. 12 and 13, the attachment of a clip-hoop 64 to the distal end of a slat 20 may be by means of a clip cap 76. The clip-hoop 64 is fixedly attached to the clip cap 76. The cap 76 has a recess or hollow on its proximate face, corresponding in size and shape (but slightly larger) to the exterior dimensions of the distal end of the slat 20, or 21. Accordingly, the cap 76 may be frictionally engaged over the distal end of the slat 20, thus to secure the cap 76 to the slat 20, and holding the clip-hoop 64 in proper position for use. Again, an adhesive optionally may be used to provide for a relatively permanent attachment of the cap 76 upon the slat 20; a mere frictional engagement promotes easy removal and replacement of the clip-hoop 64 should it become necessary.

With combined reference to FIGS. 10-13, one possible functional configuration of the clip portion 65 is indicated. There may be provided, for example, a clamp 80 and clamp tube 82 that combine to function as the clip portion 65. The clamp 80 is a resilient (e.g. plastic) roughly semi-cylindrical component insertable, for example, into a slot aperture through the wall of the clamp tube 82. The clamp 80 compresses to fit through the slot, and then elastically rebounds within the interior of the clamp tube 82 to snap into place therein, and thus pinch or grip the flexible connector cord 41; the cord 41 is gripped between the clamp 80 and the inside wall of the clamp tube 82. The hoop portion 66 is molded integrally with, or affixed to, the clamp 80. The hoop portion 66 may offer the dual function of a handle for the user's manipulation of the clamp 80, to insert and withdraw the latter in relation to the clamp tube 82.

The blind apparatus 10 optionally can be motorized. This alternative embodiment is similar in most forms and function to the embodiments previously described, except that the slat clusters are moved by motor action rather than manually or by spring assist. Referring to FIGS. 14A-14D, for each slat cluster a small electric motor 54 (FIG. 14A) is disposed on or near the base 30 such that its drive shaft 55 is in lieu of the pivot pin(s) (e.g., 32a) in previously described embodiments. The motor 54 is a suitably small motor, powered either by. AC or DC (battery), and preferably is operated (on and off, and speed, if desired) by a conventional electronic control (in-circuit switching, or radio- or infrared remote control, or the like). The drive shaft 55 passes through shaft holes in proximate ends of the slats 20 (eleven slats shown in FIG. 14A), which shaft holes are co-aligned as in other embodiments, and the shaft 55 also is rotatably journaled in corresponding pivot apertures in the upright sides of the base 30. As suggested in FIG. 14B, the radial cross-section of the motor drive shaft 55 is hexagonal (or some other suitable polygon, such as a square or triangle).

The embodiment of FIGS. 14A-D has a plurality (e.g., ten in FIG. 14A) of passive slats 20 and a single lead slat 21 that is the “driven” slat. The proximate end of the slat of a driven lead slat 21 is depicted in FIG. 14C, while the proximate end of the slat of a passive slat 20 is shown in FIG. 14D. It is seen that the shaft hole 56 in the driven lead slat 21 corresponds closely in size and shape to the cross-section of the drive shaft 55. In distinction, the shaft hole 57 in the proximate end of each passive slat 20 preferably is a circle having a radius greater than the maximum radial dimension of the drive shaft 55 (in relation to its axis of rotation). Indeed, the shaft holes 57 in the passive slats can be practically any shape (the rounder the better), so long as they are large enough to permit the motor drive shaft 55 freely to rotate in the holes 57 without engaging the slats 20. The lead slat 21 is mounted at the distal end of the drive shaft (FIG. 14A). The correspondence in size and shape between the shaft 55 and the shaft hole 56 results in a close fit of the shaft 55 in the hole 56. The lead slat 21 accordingly is securely engaged with the shaft 55, with the result that rotation of the shaft causes powered pivoting of the lead slat. When the lead slat 21 moves under the power of the motor 54, it pulls the passive slats 20 serially behind it per the action of the flexible connectors 41 (FIG. 3); the passive slats thus freely swing about the shaft, between their deployed positions and their stowed positions at the base 30.

Spacer washers (not shown) may be provided along the shaft 55 and between adjacent slats 20, if needed, to separate the slats and to promote slipping movement between them. Also, suitable annular bushings (not shown) may be disposed in the shaft holes 57 to promote smooth rotation of the shaft 55 and passive slats 20 with respect to one another, and to reduce wear. Similarly, a locking bushing having a polygonal interior aperture corresponding to the polygonal cross-section of the shaft 55 may be disposed into the shaft hole 56 of the actively driven lead slat 21 to foster reliable engagement of the shaft 55 with the slat 21. Such a specialized bushing can be devised, for example, to permit all the slats to be fabricated with round shaft holes, but the lead slat 21 being the sole slat fitted with a bushing having a polygonal “drive” aperture fitted to the shaft 55.

To practice the simplest embodiment of the invention, a user opens and closes the blind apparatus by utilizing the pull knob 59 (FIG. 3), attached to the leading slats 21 on each of the slat clusters 22a, 22b, e.g., both the right side and the left side. A hooked or looped removable extension rod may be used to grasp the pull knob 59 on apparatuses situated in windows positioned out of the reach of the user, but still within the reasonable reach of the extension rod. Grasping the knob 59 the user can push/pull the lead slat 21 in each cluster to pivot the slats 20, about their respective pivotal axis, between a window open and a window closed position, As a lead slat 21 is swung to the desired position, the other slats 20 are pulled along behind, due to the flexible interconnectivity provided by the string of connector cords 41. When the lead slat is moved to its fully deployed position, for example to the position seen in FIG. 3 (at right angles to the base 30), the fasteners 43, 44 are engaged (as by magnetism or friction) to hold the fanned array of slats in the window closed condition seen in FIG. 1.

When it is desired to uncover the window, the knob 59 is again grasped, and gentle force applied to the lead slat 21 to disconnect the fasteners 43, 44; the lead slat 21 is pivoted about its axis, and swung into a position against and parallel to the base 30. The other slats 20 are pulled and/or fall under gravity into parallel mutual adjacency, and the slats are in the window open condition. Preferably, when stowed against the base 30 in the window open condition, all the slats are disposed between, and concealed by, the parallel extending sides of a trough-like base 30, as suggested by the collapsed slat cluster of the right side of FIG. 3. It is observed that the “default” condition of this embodiment is “window open”; unless a slat cluster is fully deployed so to engage the fasteners 43,44 to maintain it in a fanned-out, window-closed, position (i.e., left side of FIG. 3), the cluster will tend to fall into the retracted window-open condition (i.e., the right side of FIG. 3).

The spring-assisted embodiments of FIGS. 6 and 7 are operated and functions similarly, except that the default condition is “window closed.” The slat cluster is biased by the torsion spring 47 toward the fully deployed condition, where it remains unless and until pushed down into the collapsed condition, against the base 30, and held in such position by a locking bar 49 or similar releasable retainer.

Operation of the motorized embodiment also is evident from the foregoing, but is here summarized. The motor 54 is controllably operated to rotate its shaft 55 an appropriate amount, e.g. ninety degrees of rotation. Known electronic or physical stops of known provision may prevent the shaft from being over-rotated. When a user desires to deploy the cluster of slats from a stowed condition toward the “window closed” condition, the motor 54 is actuated to drive the lead slat 21 from its “window open” position parallel to the base 30, toward and to its fully deployed position, typically at right angles to the base 30. As the lead slat 21 undergoes powered movement toward the “window closed” condition, it sequentially pulls the passive slats 20 behind it, through the “daisy-chain” function of the flexible connectors 41 linking adjacent slats, until all the slats are pivoted into proper relative positions to define the fan-like array covering the window 50 (e.g., FIG. 1). To remove the blind covering from the window, the motor is actuated in reverse, counter-rotating the lead slat 21 toward the base 30 until it is once again stowed adjacent thereto. The passive slats 20 are again pulled behind the lead slat, and fall into stowed positions mutually parallel and also adjacent the base.

The motorized embodiment may be automatically operated by timed and/or pre-programmed circuitry, so that the blinds 10 are opened and closed at predetermined times each day, without real-time active human intervention or control. Further, known electronic circuitry means can be used to regulate precisely the extent and speed of motor shaft 55 rotation, to prevent under- or over-rotation of the shaft, or excessive shaft speed, that otherwise may compromise the performance of the apparatus.

Accordingly, there is disclosed hereby a blind for an opening 50, the blind apparatus 10 having a base 30 and at least two slat clusters 22a, 22b, each cluster having a plurality of slats 20, 21, pivotally connected to the base, and each cluster also having a pivot axis corresponding to the cluster about which the slats may pivot, wherein the slats of each cluster are movable through an arc between a first (“window open”) position in which the slats are retracted in parallel proximity to the base, and a second (“window closed”) position in which the slats are deployed in a progressively overlapping arrangement covering a sector of the arc having its vertex at the cluster's pivot axis, wherein the arc sectors of deployed slat clusters are substantially coplanar. The base preferably has a trough-like configuration with a floor and a pair of opposed extending sides, so that when a cluster is retracted to the second position, the slats are disposed between the sides of the base.

It also is disclosed that at least one, preferably all, slats in each cluster is composed of a base slat 36, a distal sleeve 38 slidably disposed over a distal end of the base slat and movable axially in relation to the base slat, and a spring 40 within the interior of the distal sleeve between the distal end of the base slat and the sleeve, and resiliently compressible between the distal end of the base slat and the inside of the sleeve. By this means, the sleeve is movable axially, against or with the force of the spring, to a plurality of positions, whereby the effective length of the slat is adjustable infinitely incrementally.

As disclosed hereinabove, a cluster of slats includes a lead slat 21 defining the leading edge, distal from the base, of the overlapping arrangement of slats when the slats are deployed to the second position, and flexible cord connectors 41 extending between adjacent slats in the cluster. A first fastener 43 optionally is disposed on the lead slat, the first fastener being releasably engageable with a second complementary fastener 44 to maintain the lead slat deployed in the second position. A torsion spring 47 may be included with a cluster, the torsion spring having a first arm 48a engaged with the lead slat, a second arm 48b engaged with the base, and a coiled body disposed generally coaxially with the pivot axis of the cluster, so that a bias of the spring tends to deploy the cluster of slats from the first position to the second position. A pull cord 51 runs through the hoop portions 66 situated at the end of each slat to permit a user controllably to operate the slats with or against the force of the spring 47.

An electric motor 54 may be situated in the disclosed blind apparatus, the motor operative to rotate a drive shaft 55 coaxial with the pivot axis of a cluster, there being a plurality of passive slats 20 disposed along the drive shaft and pivotal around the shaft, wherein the lead slat in the cluster is fixed upon the drive shaft thereby to rotate with the shaft, and the motor is operable to rotate the lead slat between the first position and the second position.

There has been disclosed one of the preferred embodiments, in which a pair of slat clusters is connected to the base, having their respective pivot axes substantially adjacent near the center of the base. In this embodiment, when both clusters are in the first (“window open”) position, they are linearly aligned longitudinally along the base, and when both clusters are deployed to the second (“window closed”) position, their respective lead slats are substantially parallel and adjacent. Each cluster preferably is movable through an arc of approximately 90 degrees, whereby when both clusters are deployed to the second position, they cover a total arc sector of approximately 180 degrees, such as would be adapted for utility inside a semi-circular window.

Other versions and embodiments of the apparatus are apparent to a person skilled in the art without departing from the spirit and scope of the invention. For example, the length of the curved arc through which each cluster of slats may pivot can be preselected to be in a range of between just a few degrees of arc and, say, about 120 degrees of arc. Thus the angular size of the arc sector covered by the progressively overlapping array of slats, when the slats are deployed to the second position, can be predetermined to be any of a wide variety of angular sizes. Further, the arc through which the slats move may be a circular arc, or may be an arc of non-uniform radius, such as a parabolic arc, or some other arch shape.

Although the invention has been described in detail with particular reference to these preferred embodiments, other embodiments can achieve the same results. Variations and modifications of the present invention will be obvious to those skilled in the art, and it is intended to cover in the appended claims all such modifications and equivalents.

What is claimed is:

1. A blind for an opening, comprising:
a base;
at least two slat clusters, each cluster having:
a plurality of slats pivotally connected to the base; and
a pivot axis corresponding to the cluster about which the slats may pivot;
wherein the slats of each cluster are movable through an arc between a first position in which the slats are retracted in parallel proximity to the base, and a second position in which the slats are deployed in a progressively overlapping arrangement covering a sector of the arc having its vertex at the cluster's pivot axis, and wherein the arc sectors of deployed slat clusters are substantially coplanar.

2. An apparatus according to claim 1 wherein the base comprises a trough-like configuration having a floor and a pair of opposed extending sides, wherein when a cluster is retracted to the second position, the slats are disposed between the sides of the base.

3. An apparatus according to claim 1 further comprising a roller disposed upon a distal tip of each slat.

4. An apparatus according to claim 1 wherein at least one slat in each cluster comprises:
base slat;
a distal sleeve slidably disposed over a distal end of the base slat and movable axially in relation to the base slat; and
a spring, within the interior of the distal sleeve between the distal end of the base slat and the sleeve, and resiliently compressible between the distal end of the base slat and the inside of the sleeve;
wherein the sleeve is movable axially, against or with the force of the spring, to a plurality of positions, whereby the effective length of the slat is adjustable infinitely incrementally.

5. An apparatus according to claim 1 wherein a cluster of slats comprises:
a lead slat defining the leading edge, distal from the base, of the overlapping arrangement of slats when the slats are deployed to the second position; and
flexible cord connectors extending between adjacent slats in the cluster.

6. An apparatus according to claim 5 further comprising a first fastener disposed on the lead slat, the first fastener releasably engageable with a second complementary fastener to maintain the lead slat deployed in the second position.

7. An apparatus according to claim 5 further comprising a torsion spring, the torsion spring having:
a first arm engaged with the lead slat;
a second arm engaged with the base; and
a coiled body coaxial with the pivot axis of the cluster;
wherein a bias of the spring tends to deploy the cluster of slats from the first position to the second position.

8. An apparatus according to claim 5 further comprising:
an electric motor operative to rotate a drive shaft coaxial with the pivot axis of the cluster; and
a plurality of passive slats disposed along the drive shaft and pivotal around the shaft;
wherein the lead slat is fixed upon the drive shaft thereby to rotate therewith, and the motor is operable to rotate the lead slat between the first position and the second position.

9. A blind apparatus for selectively covering a window, comprising:
a base;
at least two slat clusters each cluster having:
a plurality of slats pivotally connected to the base; and
a pivot axis corresponding to the cluster about which the slats may pivot;
wherein at least one slat in the cluster comprises:
base slat;
a distal sleeve slidably disposed over a distal end of the base slat and movable axially in relation to the base slat; and
a spring, within the interior of the distal sleeve between the distal end of the base slat and the sleeve, and resiliently compressible between the distal end of the base slat and the inside of the sleeve; and
wherein the sleeve is movable axially, against or with the force of the spring, to a plurality of positions, whereby the effective length of the slat is adjustable infinitely incrementally; and
wherein further the slats of each cluster are movable through an arc between a first position in which the slats are retracted in parallel proximity to the base, and a second position in which the slats are deployed in a progressively overlapping arrangement covering a sector of the arc having its vertex at the cluster's pivot axis, and wherein the arc sectors of deployed slat clusters are substantially coplanar.

10. An apparatus according to claim 9 wherein the base comprises a trough-like configuration having a floor and a pair of opposed extending sides, wherein when a cluster is retracted to the second position, the slats are disposed between the sides of the base.

11. An apparatus according to claim 9 wherein the pivot axes of the clusters are substantially proximate to the longitudinal center of the base.

12. An apparatus according to claim 9 further comprising a roller disposed upon a distal tip of each slat.

13. An apparatus according to claim 9 wherein a cluster of slats comprises:
a lead slat defining the leading edge, distal from the base, of the overlapping arrangement of slats when the slats are deployed to the second position; and
flexible cord connectors extending between adjacent slats in the cluster.

14. An apparatus according to claim 13 further comprising a first fastener disposed on the lead slat, the first fastener releasably engageable with a second complementary fastener to maintain the lead slat deployed in the second position.

15. An apparatus according to claim 13 further comprising a torsion spring, the torsion spring having:
a first arm engaged with the lead slat;
a second arm engaged with the base; and
a coiled body coaxial with the pivot axis of the cluster;
wherein a bias of the spring tends to deploy the cluster of slats from the first position to the second position.

16. An apparatus according to claim 13 further comprising:
an electric motor operative to rotate a drive shaft coaxial with the pivot axis of the cluster; and
a plurality of passive slats disposed along the drive shaft and pivotal around the shaft;
wherein the lead slat is fixed upon the drive shaft thereby to rotate therewith, and the motor is operable to rotate the lead slat between the first position and the second position.

17. An apparatus according to claim 13 comprising a pair of slat clusters connected to the base and having their respective pivot axes substantially adjacent near the center of the base, wherein:
when both clusters are in the first position, they are aligned longitudinally on the base; and
when both clusters are deployed to the second position, their respective lead slats are substantially parallel and adjacent.

18. An apparatus according to claim 17 wherein each cluster is movable through an arc of approximately 90 degrees, whereby when both clusters are deployed to the second position they cover a total arc sector of approximately 180 degrees.

19. An apparatus according to claim 18 wherein the arc is a circular arc.

20. An apparatus according to claim 19 wherein the arc has a non-uniform radius.
